(19) United States
(12) Patent Application Publication
(10) Pub. No.: US 2025/0296205 A1
(43) Pub. Date: Sep. 25, 2025

(54) Cruciform-Shaped Driver and Methods of Forming and Use

(71) Applicant: Snap-on Incorporated, Kenosha, WI (US)

(72) Inventors: Daniel M. Eggert, Kenosha, WI (US); Jeffrey M. Arendt, Kenosha, WI (US)

(21) Appl. No.: 18/613,096

(22) Filed: Mar. 21, 2024

(51) Int. Cl. B25B 15/00

(52) U.S. Cl. CPC B25B 15/005

(57) ABSTRACT

A cruciform-shaped driver is disclosed as one embodiment. The disclosed cruciform-shaped driver includes an axially elongated driver body extending from a first end to a second end; a plurality of grooves formed radially about a centerline of the driver body, wherein each of the plurality of grooves includes: a pair of driving surfaces, wherein each of the pair of driving surfaces is substantially opposed the other; a transition surface extending between each of the pair of driving surfaces; and at least one rib formed into each pair of driving surfaces, wherein the at least one rib extends towards the transition surface.

### BACKGROUND

Cruciform-shaped drivers, such as a Phillips head driver, may, when subjected to a high torque, slip out of the head of a corresponding fastener. Repetition of this slipping or camming out process may result in deformation and other harm to the fastener and possibly to the driver itself. “Cam-out,” as used herein, describes the loading and mechanical condition under which the driver slips and otherwise unintentionally disengages from the fastener under torsional loading.

### SUMMARY

Embodiments described herein relate to a cruciform-shaped driver and tool configured to reduce the effects of cam-out by increasing the mechanical engagement with a corresponding fastener. The disclosed cruciform-shaped driver and tool may enable a large torque load to be mechanically applied to a corresponding fastener with a reduced likelihood of cam-out resulting in the damage or deformation of either component. The disclosed cruciform-shaped driver and tool includes an axially extending rib formed on each of the respective driving surfaces within the four quadrants defined as part of the cruciform shape.

In a one embodiment, a cruciform-shaped driver is disclosed. The cruciform-shaped driver includes an axially elongated driver body extending from a first end to a second end; a plurality of grooves formed radially about a centerline of the driver body. Each of the plurality of grooves further includes a pair of driving surfaces, wherein each of the pair of driving surfaces is substantially opposed to the other; a transition surface extending between each of the pair of driving surfaces; and at least one rib formed into each pair of driving surfaces, wherein the at least one rib extends towards the transition surface.

In an embodiment of the cruciform-shaped driver, the elongated driver body is made from round bar stock.

In an embodiment of the cruciform-shaped driver, the elongated driver body includes a hexagonal cross-section.

In an embodiment of the cruciform-shaped driver, the first end of the elongated driver body includes at least a first taper.

In an embodiment of the cruciform-shaped driver, the plurality of grooves are formed at ninety degree (90°) intervals about the centerline.

In an embodiment of the cruciform-shaped driver, the pair of driving surfaces are non-parallel surfaces in which a distance between the pair of driving surfaces increases with the distance away from the transition surface.

In an embodiment of the cruciform-shaped driver, the transition surface separates each of the pair of driving surfaces, and the transition surface is arranged at an obtuse angle relative to the pair of driving surfaces.

In an embodiment of the cruciform-shaped driver, the transition surface and the pair of driving surfaces incorporate an irregular surface treatment.

In an embodiment of the cruciform-shaped driver, the irregular surface treatment is a particulate surface treatment applied to increase surface friction.

In an embodiment of the cruciform-shaped driver, each of the grooves is formed at a first angle α relative to the centerline of the driver body.

In an embodiment of the cruciform-shaped driver, the at least one rib is arranged skew to the centerline of the driver body.

In an embodiment of the cruciform-shaped driver, the at least one rib comprises a first rib and a second rib, the first rib is formed on a first surface of the pair of driving surfaces, the second rib is formed a second surface of the pair of driving surfaces, and the first rib extends towards the second rib.

In an embodiment of the cruciform-shaped driver, at least the first rib is a pointed rib including an apex.

In an embodiment of the cruciform-shaped driver, at least the first rib is a rounded rib.

In an embodiment of the cruciform-shaped driver, the first rib is substantially parallel to the second rib.

In an embodiment of the cruciform-shaped driver, the first rib and the second rib extend from the first end of the driver body towards the second end.

In another embodiment, a method of forming a cruciform-shaped driver is disclosed. The method includes securing an axially elongated driver body having a first end and a second end, wherein the second end is engaged by a clamp, wherein a first end extends away from the secured second end; and forming a plurality of grooves at the first end of the axially elongated driver body. The method further includes that forming each of the plurality of grooves includes indexing the clamp to position the axially elongated driver body in a forming position; and forming a pair of driving surfaces separated by a transition surface, wherein each of the pair of driving surfaces is substantially opposed the other and includes at least one rib formed into each pair of driving surfaces, wherein the at least one rib extends towards the transition surface.

In an embodiment of the method, the clamp is a radially symmetric chuck.

In an embodiment of the method, the forming position is arranged at 90° intervals.

In an embodiment of the method, the method further includes applying a particulate surface to each of the pair of driving surfaces such that the particulate surface is configured to increase surface friction.

In an embodiment of the method, forming the rib includes forming a pointed rib including an apex.

In an embodiment of the method, forming the rib includes forming a rounded rib.

In an embodiment of the method, the plurality of grooves are aligned at an angle relative to a centerline of the axially elongated driver body.

In another embodiment, a cruciform-shaped driver tool is disclosed. The cruciform-shaped driver tool a handle supporting a tool shaft, wherein the tool shaft extends along a centerline of the handle; and an axially elongated driver extending along the centerline from a first end of the tool shaft opposite to the handle. The axially elongated driver includes a plurality of grooves formed radially about the centerline. Each of the plurality of grooves includes a pair of driving surfaces, wherein each of the pair of driving surfaces is substantially opposed the other; and at least one rib formed into each pair of driving surfaces, wherein the at least one rib extends towards one of the pair of driving surfaces.

In another embodiment, a method for reducing cam-out by a cruciform-shaped driver including a handle position at a second end of a tool shaft, and a plurality of grooves provided at a first end of the tool shaft is disclosed. The method includes inserting the plurality of grooves with a complementary plurality of recesses formed within a fastener head; applying a torque load about a centerline of the tool shaft, wherein the torque load is applied to the handle; and in response to the applied torque load, engaging a pair of driving surfaces formed as part of each of the plurality of grooves with a complementary receiving surface within each of the plurality of recesses formed within the fastener head. The method further includes that engaging the pair of driving surfaces includes engaging at least one rib formed into each pair of driving surfaces, wherein the at least one rib extends towards the complementary receiving surface formed within the fastener head.

Other embodiments will become apparent to those of ordinary skill in the art by reading the following detailed description, with reference where appropriate to the accompanying drawings.

### BRIEF DESCRIPTION OF THE DRAWINGS

Example embodiments are described herein with reference to the drawings.

FIG. 1A show a tool including a cruciform-shaped driver in accordance with an example embodiment.

FIG. 1B shows a fastener compatible with the tool of FIG. 1A in accordance with an example embodiment.

FIG. 2 shows a perspective view of the cruciform-shaped driver in accordance with an example embodiment.

FIG. 3 shows a plan view of the cruciform-shaped driver in accordance with an example embodiment.

FIG. 3A shows a profile in accordance with an example embodiment for manufacturing the cruciform-shaped driver shown in FIG. 3.

FIG. 4 shows a side view of the cruciform-shaped driver in accordance with an example embodiment.

FIG. 4A shows a tool path for manufacturing the cruciform-shaped driver in accordance with an example embodiment.

FIG. 4B shows a tool path for manufacturing the cruciform-shaped driver in accordance with another example embodiment.

FIG. 5 shows a perspective view of a tip of the cruciform-shaped driver in accordance with an example embodiment.

FIG. 6 is a flowchart showing a method reducing cam-out in accordance with an example embodiment.

FIG. 7 is a flowchart showing a method forming the cruciform-shaped driver in accordance with an example embodiment.

The drawings are schematic and not necessarily to scale. In the drawings, similar symbols typically identify similar components, unless context dictates otherwise.

### DETAILED DESCRIPTION

### I. Introduction

This patent document describes example embodiments for a cruciform-shaped driver. The cruciform-shaped driver as disclosed in the example embodiments may be implemented as part of a hand tool, as a bit driver, or other tool intended to engage fasteners. The cruciform-shaped driver of the example embodiments incorporates a profile configured to limit and otherwise prevent cam-out between a driver and a complementary fastener. In other words, the configuration and profile of the discloses cruciform-shaped driver may prevent the driver from disengaging from the complementary fastener when under a torsional load.

The disclosed cruciform-shaped driver provides a user with a driver by which a large torque load be mechanically applied to a corresponding fastener with a reduced likelihood of cam-out or damaging either component. The disclosed cruciform-shaped driver includes grooves incorporating an axially extending rib formed on each of the respective driving surfaces within the four quadrants defined as part of the cruciform shape. For example, in the disclosed configuration, the four quadrants correspond to grooves formed at ninety-degree intervals (90°) about a centerline of the driver, hand tool, and other axially elongated shaft. Similarly, the axially extending ribs formed as part of each of the grooves are arranged skew to the centerline the driver, hand tool, and other axially elongated shaft.

### II. Example Cruciform-Shaped Driver

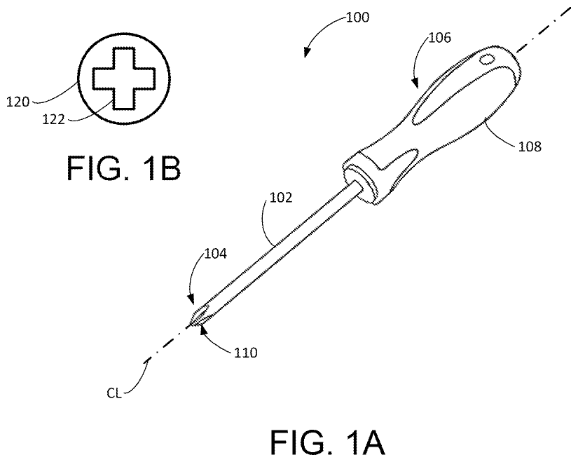

FIG. 1A shows an example embodiment of a hand tool 100 in accordance with an example embodiment. The hand tool 100 includes an elongated shaft 102 including a first end 104 and a second end 106. The elongated shaft 102 extends along a centerline CL and supports a handle 108 at the second end 106. The first end 104 may be configured as a cruciform-shaped driver 110. The elongated shaft 102 may be manufactured from bar stock such as a heat treated round stock. In some embodiments, the elongated shaft 102 may be manufactured from bar stock having a hexagonal cross-section. The elongated shaft 102 may be hardened and heat treated.

FIG. 1B shows an example embodiment of a complimentary fastener 120 configured to receive the cruciform-shaped driver 110 of the hand tool 100. The complimentary fastener 120 includes a complementary recess 122 sized and shaped to mechanically accept and engage the cruciform-shaped driver 110.

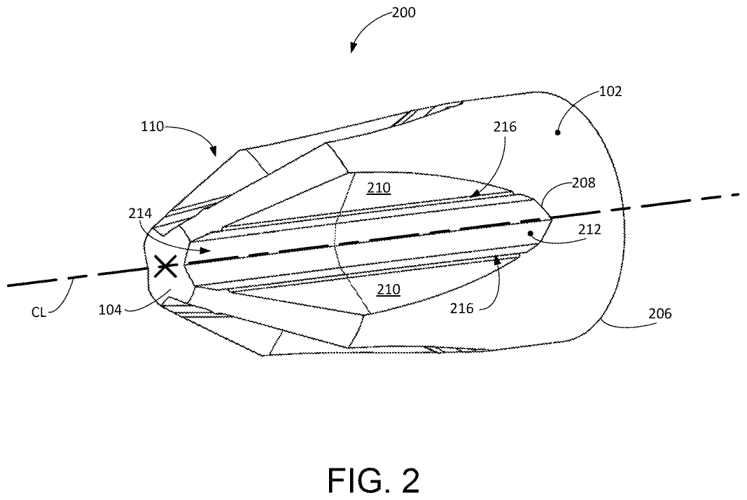

FIG. 2 shows an enlarged perspective view of the cruciform-shaped driver 110. As illustrated, the cruciform-shaped driver 110 is configured to counteract cam-out and ensure mechanical contact is maintained when a torque is applied to the complimentary fastener 120. The cruciform-shaped driver 110 may be manufactured as a driver bit 200 which includes the first end 104 extending axially to a second end 206 along a centerline CL.

The driver bit 200 incorporating the cruciform-shaped driver 110 may be formed to include a groove 214 manufactured into each quadrant defined as part of the cruciform shape. In other words, the driver bit 200 includes four (4) grooves milled, ground, or otherwise manufactured into the elongated shaft 102 at ninety-degree (90°) intervals around the centerline CL.

For example, each groove 214 formed into the driver bit 200 extends axially between the first end 104 and a second end 208 defined substantially adjacent to the second end 206. Each groove 214 includes a pair of driving surfaces 210 coupled together and separated by a transition surface 212. The pair of driving surfaces 210 are substantially opposing surfaces that combine to form a substantially v-shaped configuration in each of the grooves 214. Each driving surface 210 may further include a rib 216 extending axially along the length of the centerline defined as part of the elongated shaft 102. Each rib 216 extends away from one driving surface 210 and towards the complementary rib 216 formed into the opposing driving surface 210 of the pair of driving surfaces 210.

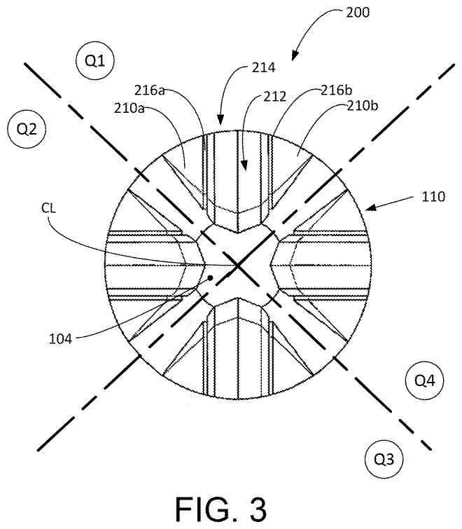

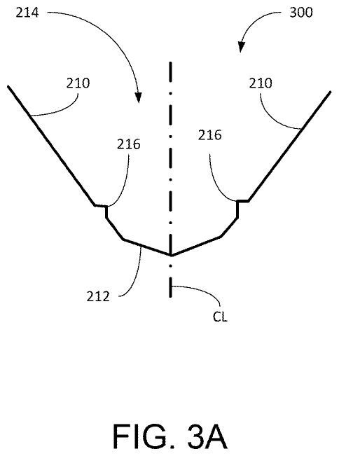

FIG. 3 shows the plan view of the first end 104 of the driver bit 200 formed to include the cruciform-shaped driver 110. The cruciform shape of the cruciform-shaped driver 110 includes four quadrants, identified as Q1-Q4, which are arranged ninety degrees (90°) apart around centerline CL. As illustrated, each of the four quadrants is substantially identical and symmetrical to one or more of the remaining quadrants.

For example, the first quadrant (Q1) as shown in FIG. 3 depicts the pair of driving surfaces 210 formed into a substantially v-shaped configuration. Each of the pair of driving surfaces 210 includes a rib 216. Each of the driving surfaces 210 and corresponding ribs 216 may be individually identified as the driving surface 210a and rib 216a, and the driving surface 210b and rib 216b. The individual driving surface 210a and driving surface 210b may be separated from each other by the transition surface 212. The rib 216a extends skew to the centerline CL as part of the driving surface 210a. Similarly, the rib 216b extends skew to the centerline CL as part of the driving surface 210b. As shown, the ribs 216a, 216b extend along the centerline CL such that they are arranged neither parallel nor at right angles to the centerline CL. The second quadrant (Q2), third quadrant (Q3), and fourth quadrant (Q4) may each have similar features and elements as the first quadrant (Q1).

FIG. 3A shows a profile 300 characteristic of the substantially v-shaped configuration. The profile 300 reflects an example of the substantially v-shaped configuration formed as part of the groove 214. As shown in FIG. 3, each of the quadrants Q1 to Q4 extends 90° about the centerline CL, and the substantially v-shaped configuration of the profile 300 may, for example, extend between about the centerline CL the when forming each of the grooves 214. In some embodiments, the substantially v-shaped configuration may be formed to reflect a Phillips configuration, or a Pozidriv configuration. For example, the profile 300 may be a tool profile. The tool profile including the profile 300 may be the shape of an exemplary cutting or grinding tool configured to manufacture the groove 214 into the elongated shaft 102. In some embodiments, the transition surface 212 may a continuous surface extending between the driving surface 210a and rib 216a, and the driving surface 210b and rib 216b. In some embodiments, each rib 216a, rib 216b may be a pointed rib extending inwards toward the centerline CL and ending with an apex. In some embodiments, each rib 216a, rib 216b may be a rounded rib extending inwards toward the centerline CL. In some embodiments, each rib 216a may reflect multiple ribs and the rib 216b may reflect multiple ribs such that the ribs extend inwards toward the centerline CL of the groove 214.

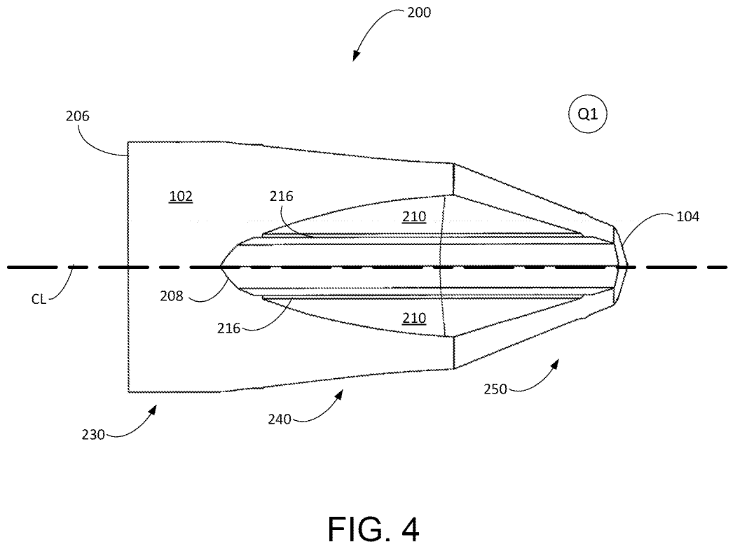

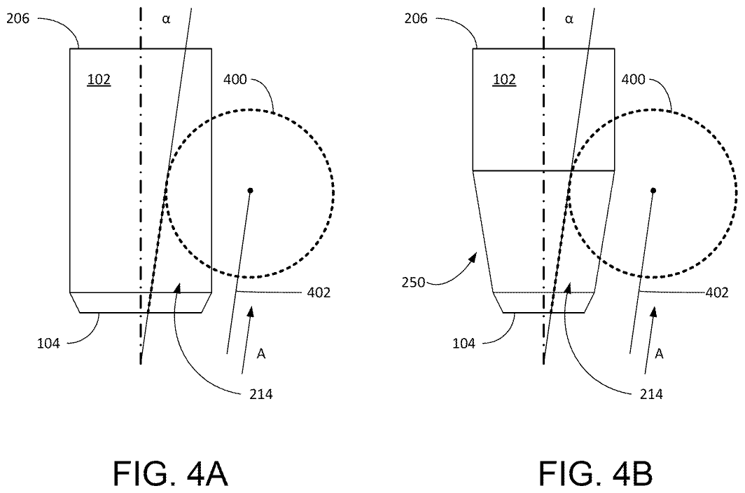

FIG. 4 shows a side view of the cruciform-shaped driver 110 arranged to engage a corresponding fastener 120 via the first end 104. FIG. 4 further depicts the groove 214 formed as part of first quadrant (Q1) as discussed above with respect to FIG. 3A. As shown in Q1, the groove 214 includes the rib 216 extending parallel to the centerline CL between the first end 104 and the position 208 substantially adjacent to the second end 206 as part of the driving surface 210. Similarly, the groove 214 includes a mirrored version of the rib 216 extending parallel to the centerline CL as part of the opposing driving surface 210.

FIG. 4 further depicts that the cruciform-shaped driver 110 is formed as part of the elongated shaft 102 which may be round stock having a first width or cross-section over distance 230. The elongated shaft 102 such as round stock may further include a first taper over distance 240 and a second taper over distance 250. The first end 104 may include an additional taper or point to aid in the engagement with the corresponding fastener. In some embodiments, the elongated shaft 102 may include a hexagonal cross-section. For example, bar stock having a hexagonal cross-section may be cut to a desired length to form the elongated shaft 102.

FIGS. 4A and 4B illustrate examples of how the grooves 214 may be formed into each of the quadrants Q1-Q4 by, for example, a carbide tool including the profile 300 shown in FIG. 3A. For example, the centerline CL of the carbide tool and the profile 300 may be aligned with the centerline CL of the elongated shaft 102 and utilized to machine each of the grooves 214. In one example, the alignment between the carbide tool and the centerline CL of the elongated shaft 102 may be accomplished using a radially symmetric clamp or chuck to secure the workpiece in a desired location. In operation, the chuck may be configured to index the workpiece at ninety-degree (90°) intervals.

FIG. 4A shows the first end 104 of one example of the elongated shaft 102 overlaid with the rotary path 400 of, for example, a carbide tool including the profile 300. The groove 214 and rib 216 are formed as the rotary path 400 removes material along the machining path 402 in the direction indicated by arrow A. In this configuration, the elongated shaft 102 and the first end 104 may be further tapered, shaped, or otherwise machined in one or more additional steps.

In an alternate configuration shown in FIG. 4B, an elongated shaft 102 may be a finished blank including a taper identified as distance 250. FIG. 4B shows the first end 104 of the elongated shaft 102 as a tapered end overlaid with the rotary path 400 of the exemplary carbide tool including the profile 300. Because the tapered end includes less materials, the groove 214 and rib 216 may be formed at a high speed as the rotary path 400 is required to remove less material along the machining path 402 in the direction indicated by arrow A. The machining path 402 may be defined relative to the centerline CL at an angle α. By adjusting the angle α relative to the centerline, the overall size and shape of the cruciform-shaped driver 110 may be defined. The angle α reflects a corresponding angle formed as part of the walls of the complementary recess 122 formed into the complimentary fastener 120. Different sizes of the cruciform-shaped driver 110 may be defined based on the angular offset, the dimensions of the elongated shaft, and other physical characteristics of the hand tool 100.

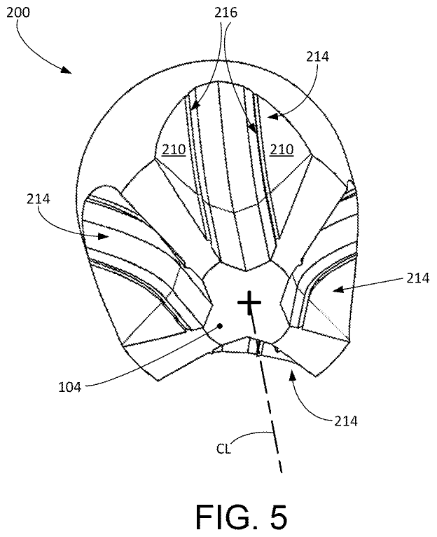

FIG. 5 shows a perspective view of the cruciform-shaped driver 110 arranged to engage a corresponding fastener via the first end 104. The cruciform shape includes four grooves 214 arranged equidistant around the centerline CL in quadrants (Q1-Q4 as shown in FIG. 3). Each pair of driving surfaces 210 defined as part of the grooves 214 is formed with the rib 216 running the length of the groove 214 such that both features are aligned substantially parallel to and skew with the centerline CL.

The arrangement of each of the ribs 216 relative to the groove 214 may limit the clearance between the cruciform-shaped driver 110 and the complimentary fastener 120. In effect, the addition of the ribs 216 reduces the mechanical clearance between the driving surfaces 210 and the walls of the complementary recess 122. The reduction in the mechanical clearance prevents slippage between the cruciform-shaped driver 110 and the corresponding fastener 120. Under application of a torque load through, for example, the handle 108, the reduction in clearance helps to prevent cam-out between the cruciform-shaped driver 110 and the corresponding fastener 120.

In other examples, a surface treatment or other means of increasing mechanical friction may be applied to the driving surfaces and the corresponding ribs to further reduce clearance and increase the mechanical engagement between the driver and the fastener. Example surface treatments and surface finishing processes may be applied to enhance appearance, corrosion resistance, and other properties of the cruciform-shaped driver 110. For example, surface treatments may include polishing, grinding, or coating with materials like chrome or nickel. In other embodiments, surface treatments may also include tungsten carbide, carbide, ceramic, or diamond particle deposition.

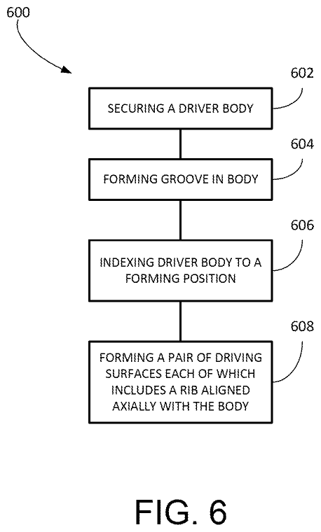

FIG. 6 is a flowchart related to an example of forming a cruciform-shaped driver. The method includes at 602 securing an axially elongated driver body having a first end and a second end, wherein the second end is engaged by a clamp, wherein a first end extends away from the secured second end. The method continues at 604 with forming a plurality of grooves at the first end of the axially elongated driver body. Forming each of the plurality of grooves, as specified by the method at 606, includes indexing the clamp to position the axially elongated driver body in a forming position. The method at 608 further includes, for each of the plurality of grooves, forming a pair of driving surfaces separated by a transition surface, wherein each of the pair of driving surfaces is substantially opposed to the other and includes a rib formed into each pair of driving surfaces, wherein the rib is arranged skew to the centerline of the driver body and extends towards the transition surface.

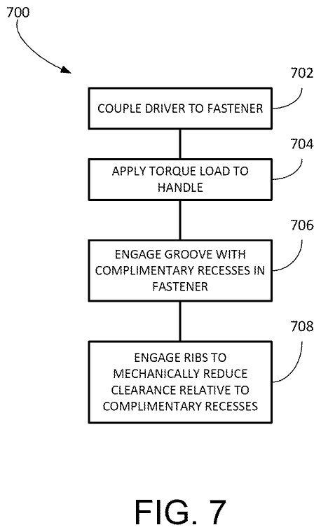

FIG. 7 is a flowchart related to an example method for reducing cam-out. The disclosed example method utilizes a cruciform-shaped driver 110 including a handle 108 positioned at a second end 106 of a tool shaft, and a plurality of grooves 214 provided at a first end 104 of the tool shaft. The method at 702 includes coupling and inserting the plurality of grooves 214 with a complementary plurality of recesses 122 formed within a fastener 120. The method continues at 704 with the application of a torque load about a centerline CL of the elongated shaft 120, wherein the torque load is applied to the handle 108. At 706, the method continues such that in response to the applied torque load, a pair of driving surfaces formed as part of each of the plurality of grooves engages with a complementary receiving surface within each of the plurality of recesses formed within the fastener head. The method at 708 further includes engaging a rib formed into each pair of driving surfaces, where the rib is arranged skew to the centerline of the tool shaft and extends towards the complementary receiving surface formed within the fastener head.

### Iv. Conclusion

It should be understood that the arrangements described herein and/or shown in the drawings are for purposes of example only and are not intended to be limiting. As such, those skilled in the art will appreciate that other arrangements and elements (e.g., machines, interfaces, functions, orders, and/or groupings of functions) can be used instead, and some elements can be omitted altogether.

While various aspects and embodiments are described herein, other aspects and embodiments will be apparent to those skilled in the art. The various aspects and embodiments disclosed herein are for purposes of illustration and are not intended to be limiting, with the true scope being indicated by the claims, along with the full scope of equivalents to which such claims are entitled. It is also to be understood that the terminology used herein for the purpose of describing embodiments only, and is not intended to be limiting.

In this description, the articles “a,” “an,” and “the” are used to introduce elements and/or functions of the example embodiments. The intent of using those articles is that there is one or more of the introduced elements and/or functions.

In this description, the intent of using the term “and/or” within a list of at least two elements or functions and the intent of using the terms “at least one of,” “at least one of the following,” “one or more of,” “one or more from among,” and “one or more of the following” immediately preceding a list of at least two components or functions is to cover each embodiment including a listed component or function independently and each embodiment including a combination of the listed components or functions. For example, an embodiment described as including A, B, and/or C, or at least one of A, B, and C, or at least one of: A, B, and C, or at least one of A, B, or C, or at least one of: A, B, or C, or one or more of A, B, and C, or one or more of: A, B, and C, or one or more of A, B, or C, or one or more of: A, B, or C is intended to cover each of the following possible embodiments: (i) an embodiment including A, but not B and not C, (ii) an embodiment including B, but not A and not C, (iii) an embodiment including C, but not A and not B, (iv) an embodiment including A and B, but not C, (v) an embodiment including A and C, but not B, (v) an embodiment including B and C, but not A, and/or (vi) an embodiment including A, B, and C. For the embodiments including component or function A, the embodiments can include one A or multiple A. For the embodiments including component or function B, the embodiments can include one B or multiple B. For the embodiments including component or function C, the embodiments can include one C or multiple C. In accordance with the aforementioned example and at least some of the example embodiments, “A” can represent a component, “B” can represent a system, and “C” can represent a symptom.

The use of ordinal numbers such as “first,” “second,” “third” and so on is to distinguish respective elements rather than to denote an order of those elements unless the context of using those terms explicitly indicates otherwise. Further, the description of a “first” element, such as a first plate, does not necessitate the presence of a second or any other element, such as a second plate.

What is claimed is:

1. A cruciform-shaped driver comprising:
an axially elongated driver body extending from a first end to a second end;
a plurality of grooves formed radially about a centerline of the driver body, wherein each of the plurality of grooves includes:
a pair of driving surfaces, wherein each of the pair of driving surfaces is substantially opposed to the other;
a transition surface extending between each of the pair of driving surfaces; and
at least one rib formed into each pair of driving surfaces, wherein the at least one rib extends towards the transition surface.

2. The cruciform-shaped driver of claim 1, wherein the elongated driver body is made from round bar stock.

3. The cruciform-shaped driver of claim 1, wherein the elongated driver body includes a hexagonal cross-section.

4. The cruciform-shaped driver of claim 1, wherein the first end of the elongated driver body includes at least a first taper.

5. The cruciform-shaped driver of claim 1, wherein the plurality of grooves are formed at ninety degree (90°) intervals about the centerline.

6. The cruciform-shaped driver of claim 1, wherein the pair of driving surfaces are non-parallel surfaces in which a distance between the pair of driving surfaces increases with the distance away from the transition surface.

7. The cruciform-shaped driver of claim 1, wherein the transition surface separates each of the pair of driving surfaces, and wherein the transition surface is arranged at an obtuse angle relative to the pair of driving surfaces.

8. The cruciform-shaped driver of claim 1, wherein the transition surface and the pair of driving surfaces incorporate an irregular surface.

9. The cruciform-shaped driver of claim 8, wherein the irregular surface is a particulate surface applied to increase surface friction.

10. The cruciform-shaped driver of claim 1, wherein each of the grooves is formed at a first angle α relative to the centerline of the driver body.

11. The cruciform-shaped driver of claim 1, wherein the at least one rib is arranged skew to the centerline of the driver body.

12. The cruciform-shaped driver of claim 1, wherein the at least one rib comprises a first rib and a second rib, wherein the first rib is formed on a first surface of the pair of driving surfaces, wherein the second rib is formed a second surface of the pair of driving surfaces, and wherein the first rib extends towards the second rib.

13. The cruciform-shaped driver of claim 12, wherein at least the first rib is a pointed rib including an apex.

14. The cruciform-shaped driver of claim 12, wherein at least the first rib is a rounded rib.

15. The cruciform-shaped driver of claim 12, wherein the first rib is substantially parallel to the second rib.

16. The cruciform-shaped driver of claim 12, wherein the first rib and the second rib extend from the first end of the driver body towards the second end.

17. A method of forming a cruciform-shaped driver, the method comprising:
securing an axially elongated driver body having a first end and a second end, wherein the second end is engaged by a clamp, wherein a first end extends away from the secured second end;
forming a plurality of grooves at the first end of the axially elongated driver body, wherein forming each of the plurality of grooves includes:
indexing the clamp to position the axially elongated driver body in a forming position; and
forming a pair of driving surfaces separated by a transition surface, wherein each of the pair of driving surfaces is substantially opposed to the other and includes at least one rib formed into each pair of driving surfaces, wherein the at least one rib extends towards the transition surface.

18. The method of claim 17 further comprising:
applying a particulate surface to each of the pair of driving surfaces such that the particulate surface is configured to increase surface friction.

19. The method of claim 17, wherein forming the at least one rib includes forming a pointed rib including an apex.

20. The method of claim 17, wherein forming the at least one rib includes forming a rounded rib.

21. The method of claim 17, wherein the plurality of grooves are aligned at an angle relative to a centerline of the axially elongated driver body.

22. A cruciform-shaped driver tool comprising:
a handle supporting a tool shaft, wherein the tool shaft extends along a centerline of the handle;
an axially elongated driver extending along the centerline from a first end of the tool shaft opposite to the handle, wherein the axially elongated driver includes:
a plurality of grooves formed radially about the centerline, wherein each of the plurality of grooves comprises:
a pair of driving surfaces, wherein each of the pair of driving surfaces is substantially opposed the other; and
at least one rib formed into each pair of driving surfaces, wherein the at least one rib extends towards one of the pair of driving surfaces.

23. A method reducing for cam-out by a cruciform-shaped driver including a handle position at a second end of a tool shaft, and a plurality of grooves provided at a first end of the tool shaft, wherein the method comprises:
inserting the plurality of grooves with a complementary plurality of recesses formed within a fastener head;
applying a torque load about a centerline of the tool shaft, wherein the torque load is applied to the handle; and
in response to the applied torque load, engaging a pair of driving surfaces formed as part of each of the plurality of grooves with a complementary receiving surface within each of the plurality of recesses formed within the fastener head, wherein engaging the pair of driving surfaces includes:
engaging at least one rib formed into each pair of driving surfaces, wherein the at least one rib extends towards the complementary receiving surface formed within the fastener head.
